(19) United States
(12) Patent Application Publication
(10) Pub. No.: US 2010/0241675 A1
(43) Pub. Date: Sep. 23, 2010

(54) BREAKING A CIRCULAR REFERENCE BETWEEN PARENT AND CHILD OBJECTS

(75) Inventors: Robert W. Young, Seattle, WA (US); Yu Shao, Kenmore, WA (US); Rui Liang, Sammamish, WA (US); Yiu-Ming Leung, Kirland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/406,963

(22) Filed: Mar. 19, 2009

(51) Int. Cl. G06F 17/30

(52) U.S. Cl. 707/815; 707/E17.005; 707/E17.055; 717/116

(57) ABSTRACT

Architecture that automatically breaks the circular reference between objects without any different logic by introducing a helper object called a child object container. The child object is contained within the container object and both share a reference counter. The parent object holds a strong reference to the container object. When adding a reference to the child object both the shared reference counter and the parent reference counter increase. When releasing a reference to the child object both the shared reference counter and the parent reference counter decrease. This approach provides a systematic way of solving the circular reference problem that does not rely on any weak-reference feature provided by the programming language.

### BACKGROUND

In the increasingly complex world of software engineering and programming, the efficient management of memory is critical. Proper management of data objects and resources (e.g., memory or other objects) is important to the efficient operation of the software, as well as the overall user experience. A reference is a data type that refers to an object or memory. References need to be managed by destruction once the reference is no longer there to manage memory. A common technique for reference management is to use a reference counting to de-allocate objects that are no longer referenced. A counter embedded with the object tracks the number of references by increasing the count when a reference is added or decreasing the count when a reference is removed.

A common problem in programming models that use referencing is that of circular referencing where in a series of objects (code) the last object in the series references the first object thereby invalidating the entire object series. There are several ways to avoid or break the circular reference problem. One approach only utilizes a “weak” reference (in C++, this means a raw pointer) to the parent object. This approach assumes that the parent object life span will always be longer than child life span; however, this is not always true. Another approach is to rely on a manual way (e.g., calling a method) to break the circular reference. However, the requirement of an extra step is not ideal and imposes more responsibility on the user of those objects.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture automatically breaks the circular reference between objects without any different logic by introducing a helper object called a child object container. The child object is contained within the container object and both share a reference counter. The parent object holds a strong reference to the container object. When adding a reference to the child object both the shared reference counter and the parent reference counter increase. When releasing a reference to the child object both the shared reference counter and the parent reference counter decrease. This approach provides a systematic way of solving the circular reference problem that does not rely on any weak-reference feature provided by the programming language.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented object management system in accordance with the disclosed architecture.

FIG. 2 illustrates an alternative embodiment of an object management system where a parent object has a reference relationship with multiple child object containers.

FIG. 3 illustrates an alternative embodiment of an object management system where the child object container has a reference relationship with a second child object container.

FIG. 4 illustrates a computer-implemented method of managing objects.

FIG. 5 illustrates additional aspects of the method of FIG. 4

FIG. 6 illustrates a block diagram of a computing system operable to execute a parent and child object relationship to address the circular reference problem in accordance with the disclosed architecture.

FIG. 7 illustrates a schematic block diagram of a computing environment in which a parent and child object relationship is applied to break a circular reference.

### DETAILED DESCRIPTION

The disclosed architecture solve the circular reference problem by keeping a parent object alive while there is any external reference to the child object. A helper object, called child object container (a template class) is introduced to solve this problem. The child object is contained within the container object and shares a reference counter with the container object, and the shared counter synchronizes with the parent counter during adding or releasing of references, thereby keeping the parent object alive as long as there is any external reference to the child object. When all external references to parent and child objects are released, parent object destructs first, and in turn, the container object is automatically destroyed along with the child object.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

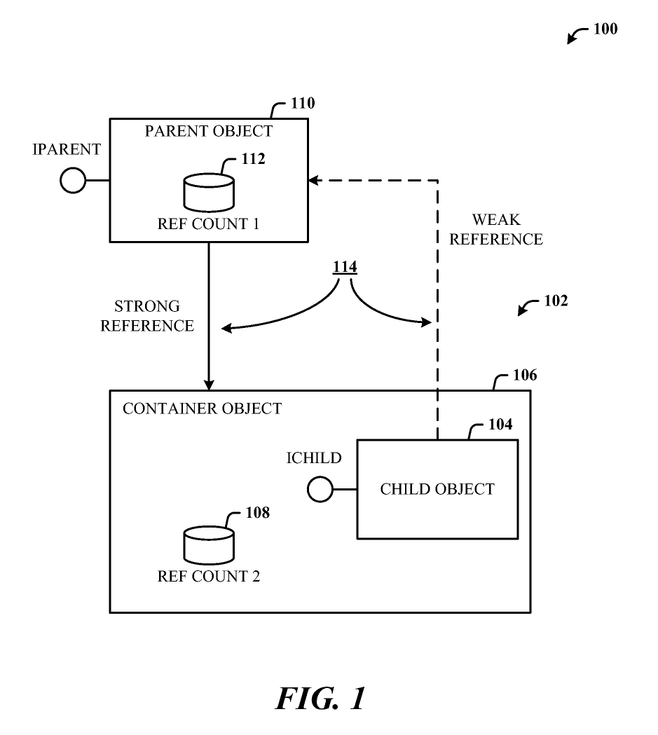

FIG. 1 illustrates a computer-implemented object management system 100 in accordance with the disclosed architecture. The system 100 includes a child object container 102 having a child object 104 in a container object 106, and a counter 108 shared by the container object 106 and the child object 104. The system 100 also includes a parent object 110 having a parent counter 112, where the parent object 110 has a relationship 114 between the child object 104 and the container object 106. The relationship 114 facilitates breaking a circular reference.

The part of the relationship 114 from the parent object to the container object includes a strong reference (denoted with a solid line). The relationship from the child object to the parent object includes a weak reference (denoted with a dashed line). The shared counter 108 and the parent counter 112 increase in synchronism when adding a reference to the child object 104. Similarly, the shared counter 108 and the parent counter 112 decrease in synchronism when releasing a reference to the child object 104. The parent object 110 destructs when all external references to the parent object 110 and child object 104 are released.

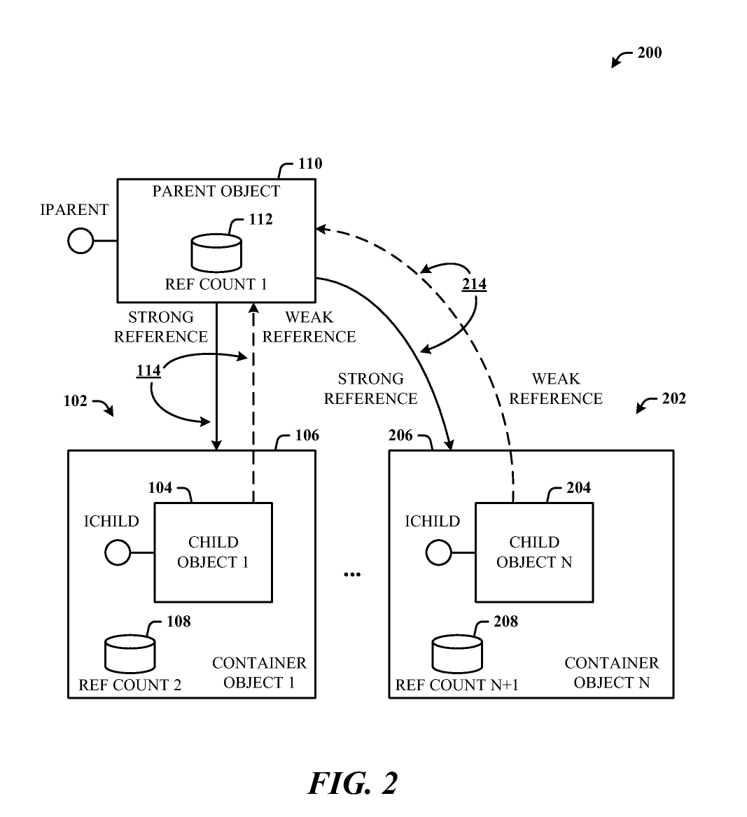

FIG. 2 illustrates an alternative embodiment of an object management system 200 where a parent object has a reference relationship with multiple child object containers. The system 200 includes the child object container 102 having the child object 104 in the container object 106, and the counter 108 shared by the container object 106 and the child object 104. The system 200 also includes the parent object 110 having the parent counter 112, where the parent object 110 has the relationship 114 between the child object 104 and the container object 106. The relationship 114 facilitates breaking a circular reference.

The parent object 110 can also have corresponding relationships with other parent objects and child objects of other child object containers. For example, the system 200 can include an Nth child object container 202 having an Nth child object 204 in an Nth container object 206, and an Nth counter 208 shared by the Nth container object 206 and the Nth child object 204. The parent object 110 has an Nth relationship 214 between the Nth child object 204 and the Nth container object 206. The Nth relationship 214 facilitates breaking a circular reference.

The Nth shared counter 208 and the parent counter 112 increase in synchronism when adding a reference to the Nth child object 204. Similarly, the Nth shared counter 208 and the parent counter 112 decrease in synchronism when releasing a reference to the Nth child object 204. The parent object 110 destructs when all external references to the parent object 110 and, the child object 104 and Nth child object 204 are released.

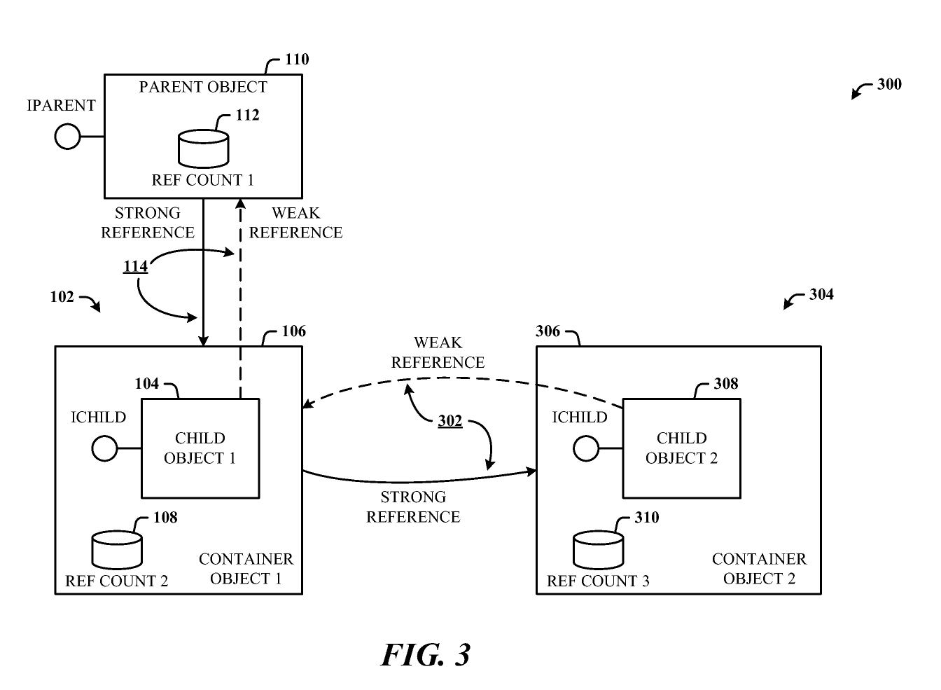

FIG. 3 illustrates an alternative embodiment of an object management system 300 where the child object container 102 has a reference relationship 302 with a second child object container 304 (also referred to as an offspring object). The second child object container 304 includes a second container 306 that includes a second child object 308 and a second shared counter 310. Here, the parent object 110 destructs when all external references to the parent object 110 and, the child object 104 and offspring object 308 are released. Note that although illustrated as having a single offspring (the second child object container 304), it is to be understood that the child object container 102 can have multiple offspring containers and corresponding reference relationships.

Put another way, the system 300 comprises the child object container 102 having the child object 104 in the container object 106, and the counter 108 shared by the container object 106 and the child object 104. The parent object 110 has the parent counter 112 and the relationship 114 between the child object 104 and the container object 106. The circular reference problem is solved by the parent object 110 destructing when all external references to the parent object 110 and child object 104 are released.

The relationship 114 from the parent object to the container object includes the strong reference and the relationship 114 from the child object to the parent object includes the weak reference. The shared counter 108 and the parent counter 112 increase when adding a reference to the child object 104 and decrease when releasing a reference to the child object 104. The parent object 110 has corresponding relationships with other child objects (e.g., the Nth child object 204) of other child object containers (e.g., the Nth child object container 202). The child object 104 has further reference relationships (the reference relationship 302) with one or more offspring objects (e.g., the second child object container 304).

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

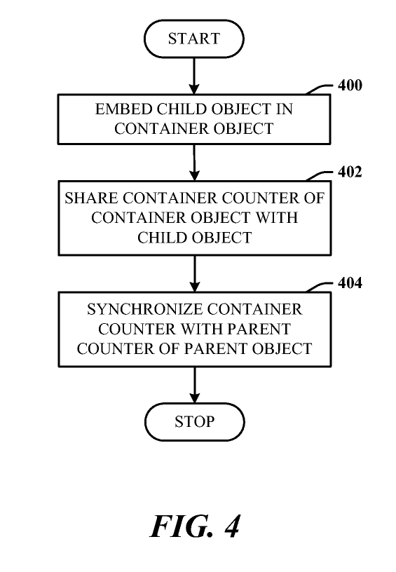

FIG. 4 illustrates a computer-implemented method of managing objects. At 400, a child object is embedded in a container object. At 402, a container counter of the container object is shared with the child object. At 404, the container counter is synchronized with a parent counter of a parent object.

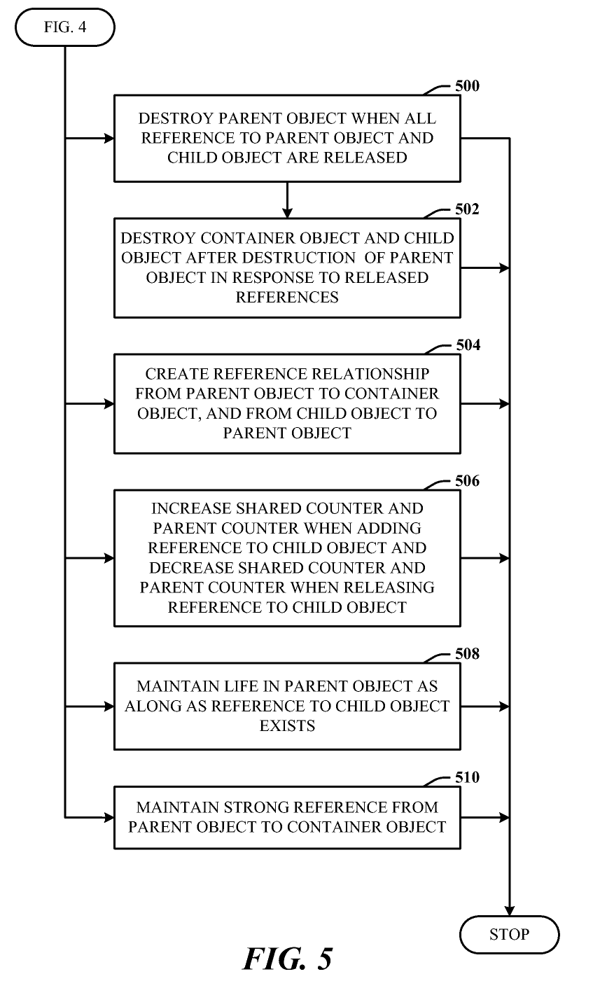

FIG. 5 illustrates additional aspects of the method of FIG. 4. At 500, the parent object is destroyed when all references to the parent object and child object are released. At 502, the container object and child object are destroyed after destruction of the parent object in response to the released references. At 504, a reference relationship is created from the parent object to the container object, and from the child object to the parent object. At 506, the shared counter and the parent counter are increased when adding a reference to the child object and decreased the shared counter and the parent counter when releasing a reference to the child object. At 508, the life in the parent object is maintained as long a reference to the child object exists. At 510, a strong reference is maintained from the parent object to the container object.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

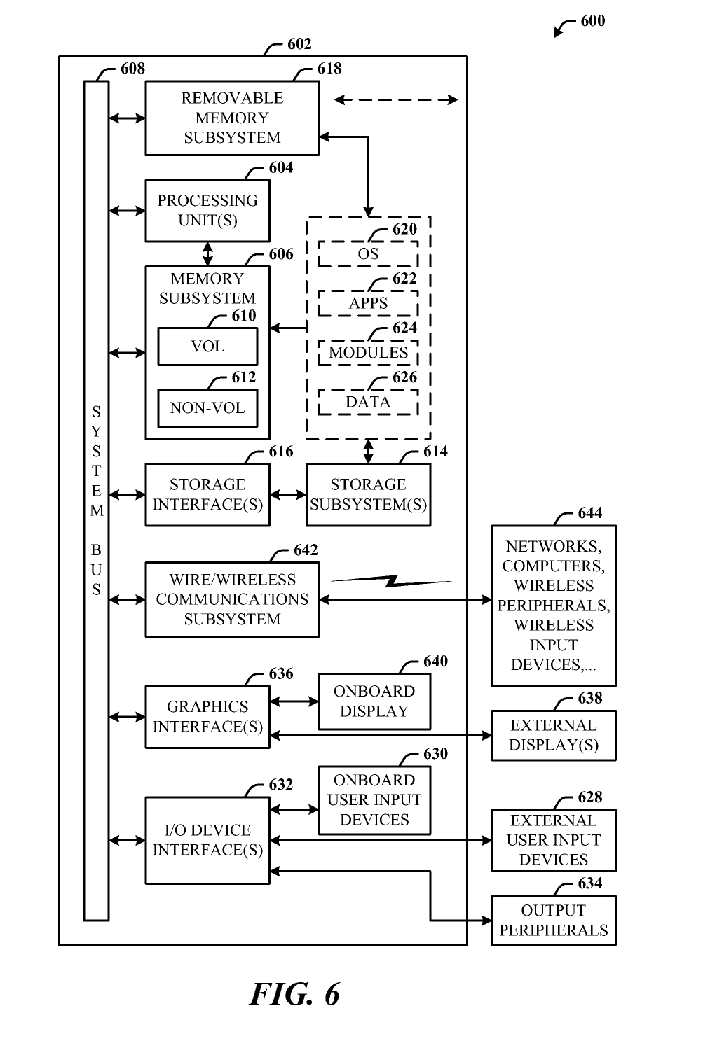

Referring now to FIG. 6, there is illustrated a block diagram of a computing system 600 operable to execute a parent and child object relationship to address the circular reference problem in accordance with the disclosed architecture. In order to provide additional context for various aspects thereof, FIG. 6 and the following discussion are intended to provide a brief, general description of the suitable computing system 600 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 600 for implementing various aspects includes the computer 602 having processing unit(s) 604, a system memory 606, and a system bus 608. The processing unit(s) 604 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 606 can include volatile (VOL) memory 610 (e.g., random access memory (RAM)) and non-volatile memory (NON-VOL) 612 (e.g., ROM, EPROM, EEPROM, etc.). A basic input/output system (BIOS) can be stored in the non-volatile memory 612, and includes the basic routines that facilitate the communication of data and signals between components within the computer 602, such as during startup. The volatile memory 610 can also include a high-speed RAM such as static RAM for caching data.

The system bus 608 provides an interface for system components including, but not limited to, the memory subsystem 606 to the processing unit(s) 604. The system bus 608 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 602 further includes storage subsystem(s) 614 and storage interface(s) 616 for interfacing the storage subsystem(s) 614 to the system bus 608 and other desired computer components. The storage subsystem(s) 614 can include one or more of a hard disk drive (HDD), a magnetic floppy disk drive (FDD), and/or optical disk storage drive (e.g., a CD-ROM drive DVD drive), for example. The storage interface(s) 616 can include interface technologies such as EIDE, ATA, SATA, and IEEE 1394, for example.

One or more programs and data can be stored in the memory subsystem 606, a removable memory subsystem 618 (e.g., flash drive form factor technology), and/or the storage subsystem(s) 614, including an operating system 620, one or more application programs 622, other program modules 624, and program data 626. Generally, programs include routines, methods, data structures, other software components, etc., that perform particular tasks or implement particular abstract data types. The one or more application programs 622, other program modules 624, and program data 626 can include the system 100 of objects and object relationship of FIG. 1, the system 200 of objects and object relationships of FIG. 2, the system 300 of objects and object relationships of FIG. 3, and the methods represented by the flow charts of FIGS. 4-5 for example.

All or portions of the operating system 620, applications 622, modules 624, and/or data 626 can also be cached in memory such as the volatile memory 610, for example. It is to be appreciated that the disclosed architecture can be implemented with various commercially available operating systems or combinations of operating systems (e.g., as virtual machines).

The storage subsystem(s) 614 and memory subsystems (606 and 618) serve as computer readable media for volatile and non-volatile storage of data, data structures, computer-executable instructions, and so forth. Computer readable media can be any available media that can be accessed by the computer 602 and includes volatile and non-volatile media, removable and non-removable media. For the computer 602, the media accommodate the storage of data in any suitable digital format. It should be appreciated by those skilled in the art that other types of computer readable media can be employed such as zip drives, magnetic tape, flash memory cards, cartridges, and the like, for storing computer executable instructions for performing the novel methods of the disclosed architecture.

A user can interact with the computer 602, programs, and data using external user input devices 628 such as a keyboard and a mouse. Other external user input devices 628 can include a microphone, an IR (infrared) remote control, a joystick, a game pad, camera recognition systems, a stylus pen, touch screen, gesture systems (e.g., eye movement, head movement, etc.), and/or the like. The user can interact with the computer 602, programs, and data using onboard user input devices 630 such a touchpad, microphone, keyboard, etc., where the computer 602 is a portable computer, for example. These and other input devices are connected to the processing unit(s) 604 through input/output (I/O) device interface(s) 632 via the system bus 608, but can be connected by other interfaces such as a parallel port, IEEE 1394 serial port, a game port, a USB port, an IR interface, etc. The I/O device interface(s) 632 also facilitate the use of output peripherals 634 such as printers, audio devices, camera devices, and so on, such as a sound card and/or onboard audio processing capability.

One or more graphics interface(s) 636 (also commonly referred to as a graphics processing unit (GPU)) provide graphics and video signals between the computer 602 and external display(s) 638 (e.g., LCD, plasma) and/or onboard displays 640 (e.g., for portable computer). The graphics interface(s) 636 can also be manufactured as part of the computer system board.

The computer 602 can operate in a networked environment (e.g., IP) using logical connections via a wired/wireless communications subsystem 642 to one or more networks and/or other computers. The other computers can include workstations, servers, routers, personal computers, microprocessor-based entertainment appliance, a peer device or other common network node, and typically include many or all of the elements described relative to the computer 602. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 602 connects to the network via a wired/wireless communication subsystem 642 (e.g., a network interface adapter, onboard transceiver subsystem, etc.) to communicate with wired/wireless networks, wired/wireless printers, wired/wireless input devices 644, and so on. The computer 602 can include a modem or has other means for establishing communications over the network. In a networked environment, programs and data relative to the computer 602 can be stored in the remote memory/storage device, as is associated with a distributed system. It will be appreciated that the network connections shown are exemplary and other means of establishing a communications link between the computers can be used.

The computer 602 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

The illustrated aspects can also be practiced in distributed computing environments where certain tasks are performed by remote processing devices that are linked through a communications network. In a distributed computing environment, program modules can be located in local and/or remote storage and/or memory system.

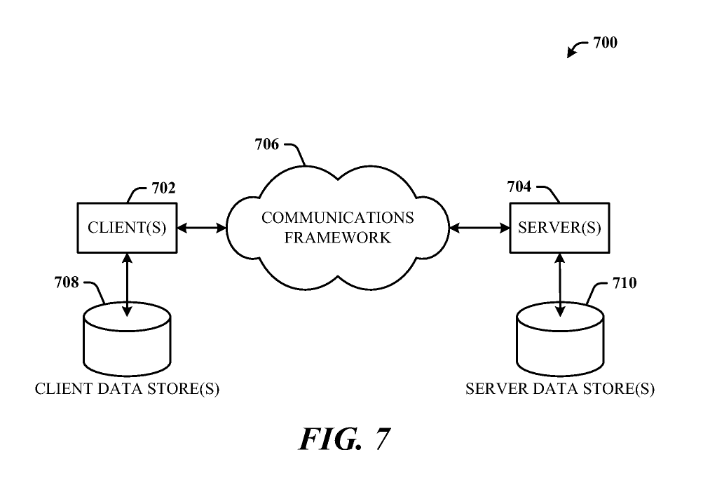

Referring now to FIG. 7, there is illustrated a schematic block diagram of a computing environment 700 in which a parent and child object relationship is applied to break a circular reference. The environment 700 includes one or more client(s) 702. The client(s) 702 can be hardware and/or software (e.g., threads, processes, computing devices). The client(s) 702 can house cookie(s) and/or associated contextual information, for example.

The environment 700 also includes one or more server(s) 704. The server(s) 704 can also be hardware and/or software (e.g., threads, processes, computing devices). The servers 704 can house threads to perform transformations by employing the architecture, for example. One possible communication between a client 702 and a server 704 can be in the form of a data packet adapted to be transmitted between two or more computer processes. The data packet may include a cookie and/or associated contextual information, for example. The environment 700 includes a communication framework 706 (e.g., a global communication network such as the Internet) that can be employed to facilitate communications between the client(s) 702 and the server(s) 704.

Communications can be facilitated via a wire (including optical fiber) and/or wireless technology. The client(s) 702 are operatively connected to one or more client data store(s) 708 that can be employed to store information local to the client(s) 702 (e.g., cookie(s) and/or associated contextual information). Similarly, the server(s) 704 are operatively connected to one or more server data store(s) 710 that can be employed to store information local to the servers 704.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented object management system, comprising:
a child object container having a child object in a container object, and a counter shared by the container object and the child object; and
a parent object having a parent counter and a relationship between the child object and the container object, the relationship for breaking a circular reference.

2. The system of claim 1, wherein the relationship from the parent object to the container object includes a strong reference.

3. The system of claim 1, wherein the relationship from the child object to the parent object includes a weak reference.

4. The system of claim 1, wherein the shared counter and the parent counter increase when adding a reference to the child object.

5. The system of claim 1, wherein the shared counter and the parent counter decrease when releasing a reference to the child object.

6. The system of claim 1, wherein the parent object destructs when all external references to the parent object and child object are released.

7. The system of claim 1, wherein the parent object has corresponding relationships with other child objects of other child object containers.

8. The system of claim 1, wherein the child object has further reference relationships with one or more offspring objects.

9. A computer-implemented object management system, comprising:
a child object container having a child object in a container object, and a counter shared by the container object and the child object; and
a parent object having a parent counter and a relationship between the child object and the container object, the parent object destructs when all external references to the parent object and child object are released to break a circular reference.

10. The system of claim 9, wherein the relationship from the parent object to the container object includes a strong reference and the relationship from the child object to the parent object includes a weak reference.

11. The system of claim 9, wherein the shared counter and the parent counter increase when adding a reference to the child object and decrease when releasing a reference to the child object.

12. The system of claim 9, wherein the parent object has corresponding relationships with other child objects of other child object containers.

13. The system of claim 9, wherein the child object has further reference relationships with one or more offspring objects.

14. A computer-implemented method of managing objects, comprising:
embedding a child object in a container object;
sharing a container counter of the container object with the child object; and
synchronizing the container counter with a parent counter of a parent object.

15. The method of claim 14, further comprising destroying the parent object when all references to the parent object and child object are released.

16. The method of claim 15, further comprising destroying the container object and child object after destruction of the parent object in response to the released references.

17. The method of claim 14, further comprising creating a reference relationship from the parent object to the container object, and from the child object to the parent object.

18. The method of claim 14, further comprising increasing the shared counter and the parent counter when adding a reference to the child object and decreasing the shared counter and the parent counter when releasing a reference to the child object.

19. The method of claim 14, further comprising maintaining life in the parent object as long a reference to the child object exists.

20. The method of claim 14, further comprising maintaining a strong reference from the parent object to the container object.
